(19) United States
(12) Patent Application Publication
(10) Pub. No.: US 2012/0246653 A1
(43) Pub. Date: Sep. 27, 2012

(54) GENERIC COMMAND PARSER

(75) Inventors: Gil BORUHOVSKI, Rehovot (IL); Polina Aronsky, Rishon LeZion (IL)

(73) Assignee: INFINIDAT LTD., Herzliya (IL)

(21) Appl. No.: 13/070,119

(22) Filed: Mar. 23, 2011

(51) Int. Cl. G06F 9/46

(52) U.S. Cl. 718/102

(57) ABSTRACT

A requesting processing unit includes a generic-parser is described, which is adapted to operate together with a specifically configured one or more command-files. A command-file includes one or more structured data elements descriptive of a command, which is available for execution by the processing unit. The data included in the command-file is registered in the computer memory associated with the processing unit. In general generic-parser is configured, in response to an issued command to search, in the computer memory, for data comprised in the data-elements, which is now registered in the computer memory, including information corresponding to the command and use this data in order to generate a request to perform the command.

### FIELD OF THE PRESENTLY DISCLOSED SUBJECT MATTER

The disclosed subject matter relates to the general field of client server communication.

### BACKGROUND

Today many computer architectures are designed to enable the distribution of tasks between pluralities of processing units where each processing unit is designated for performing specific tasks. Such processing units can be located on the same or on different computers and can be made operable to communicate via some type of communication network or other communication facility. In many cases distributed computer architectures are used in order to make the processing services of one processing unit available to one or more other processing units. Examples of computer systems utilizing distributed computer architecture include, for example, client-server networks, peer-to-peer networks and cloud computing architectures.

As apparent from the examples above, often, one processing unit (a serving processing unit) in a distributed network performs a task in response to a request issued by another processing unit (a requesting processing unit) connected to the same network. To that end, a requesting processing unit is configured to enable generating and sending a request to a serving processing unit and the serving processing unit is configured to receive the request and complete the task. In some cases the serving processing unit is also operable to send a response back to the requesting processing unit in reply to an incoming request. A response may include different types of information, for example, specific information requested by the requesting processing unit, a message indicating that the request has safely reached its destination, or it may comprise status information informing e.g. whether the server has successfully completed the task or whether the server failed to do so. The requesting processing units are further configured to read these responses.

### SUMMARY

According to a first aspect of the presently disclosed subject matter there is provided a method of operating a processing unit, the method comprising, in run-time: obtaining by said processing unit a command-object corresponding to a command, said command being designated to said processing unit and being related to a task to be performed by a second processing unit; searching, in a data structure comprised in a memory associated with said processing unit, for information in respect of said command, wherein said data structure corresponds to a command-file, said command-file is descriptive of said command, and is generated before run-time in correspondence with said command and comprises one or more structured data elements; generating by said processing unit one or more communication-objects corresponding to said information in respect of said command; and sending at least one of said generated communication-objects to said second processing unit thereby requesting said second processing unit to perform said task.

According to another aspect of the presently disclosed subject matter there is provided a method of enabling a first processing unit, in response to a command designated to said first processing unit and being related to a task to be performed by a second processing, to request from said second processing unit to perform said task, the method comprising: generating a command-file, said command-file descriptive of at least said command and comprising one or more structured data-elements; registering data comprised in the data-elements in a data structure stored in a memory associated with said first processing unit and available to said first processing unit in run-time, thereby enabling said first processing unit to generate in run-time, with the help of said information, one or more communication objects corresponding to said command; said communication object includes at least a request-object, said request-object being configured to be sent to said second processing unit and request said second processing unit to perform a respective task.

According to another aspect of the presently disclosed subject matter there is provided a first processing unit operable, in response to a command, to request from a second processing unit to perform a respective task, wherein the first processing unit is operable to obtain a command-object corresponding to said command and comprises: a generic parser and a communication module, wherein the generic parser is operable to search, in a data structure, comprised in a memory associated with said first processing unit, for information in respect of said command; wherein said data structure corresponds to a command-file, said command-file is generated before run-time in correspondence with said command and comprises one or more structured data elements descriptive of said command; said generic parser is further operable to generate one or more communication-objects corresponding to said information in respect of said command; and said communication module is operable to send at least one of said generated communication-objects to said second processing unit thereby requesting said second processing unit to perform said task.

According to another aspect of the present invention there is provided a generic parser operatively connectable to a first processing unit, operable, in response to a command, to request from a second processing unit to perform a respective task, wherein the first processing unit is operable to obtain a command-object corresponding to said command, said generic parser is operable responsive to receiving said command-object to search, in a data structure, comprised in a memory associated with said first processing unit, for information in respect of said command; wherein said data structure corresponds to a command-file, said command-file is generated in advance in correspondence with said command and comprises one or more structured data elements descriptive of said command; and generate at least one or more communication-objects corresponding to said information in respect of said command; thereby enabling said first processing unit to send at least one of said generated communication-objects to said second processing unit and request said second processing unit to perform said task. Add the same thing—information includes for generating before run time comm. classes for first and second from command file alone.

According to yet another aspect of the present invention there is provided a program storage device readable by machine, tangibly embodying a program of instructions executable by the machine to perform method steps of operating a processing unit, the method comprising: obtaining by a first processing unit a command-object corresponding to a command, said command being designated to said first processing unit and being related to a task to be performed by a second processing unit; searching, in a data structure comprised in a memory associated with said first processing unit, for information in respect of said command, wherein said data structure corresponds to a command-file, said command-file is descriptive of said command, and is generated in advance in correspondence with said command and comprises one or more structured data elements; generating by said first processing unit one or more communication-objects corresponding to said information in respect of said command; and sending at least one of said generated communication-objects to said second processing unit thereby requesting said second processing unit to perform said task.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 showing a block diagram schematically illustrating a first processing unit connected to a second processing unit, in accordance with the presently disclosed subject matter;

FIG. 2 a flowchart showing the principle operations carried out, in accordance with the presently disclosed subject matter;

FIG. 3 is flowchart showing the operations carried out by requesting processing unit 110 during runtime, in accordance with the disclosed subject matter; and

FIG. 4 is a block diagram schematically illustrating functional components of generic parser 116, in accordance with the presently disclosed subject matter.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “searching”, “generating”, “searching”, “registering”, “identifying”’, “converting”, “validating”, “utilizing” or similar terms specified in the description below, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

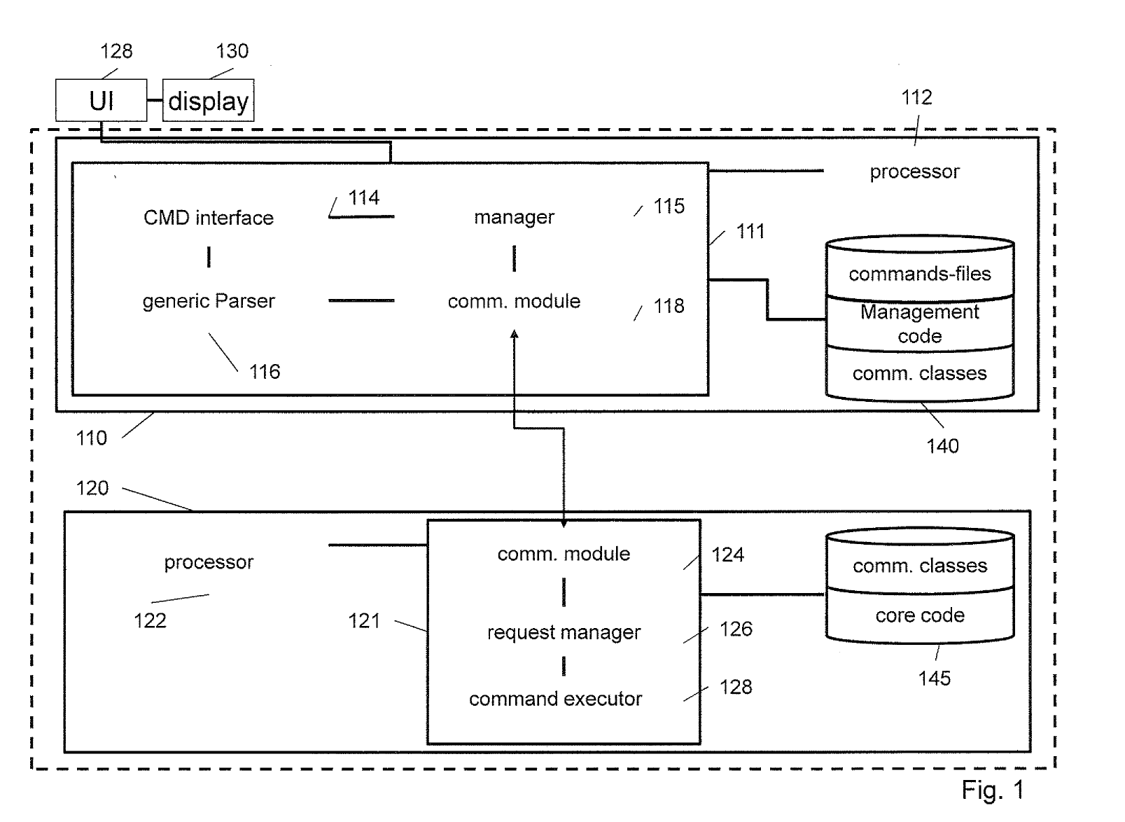

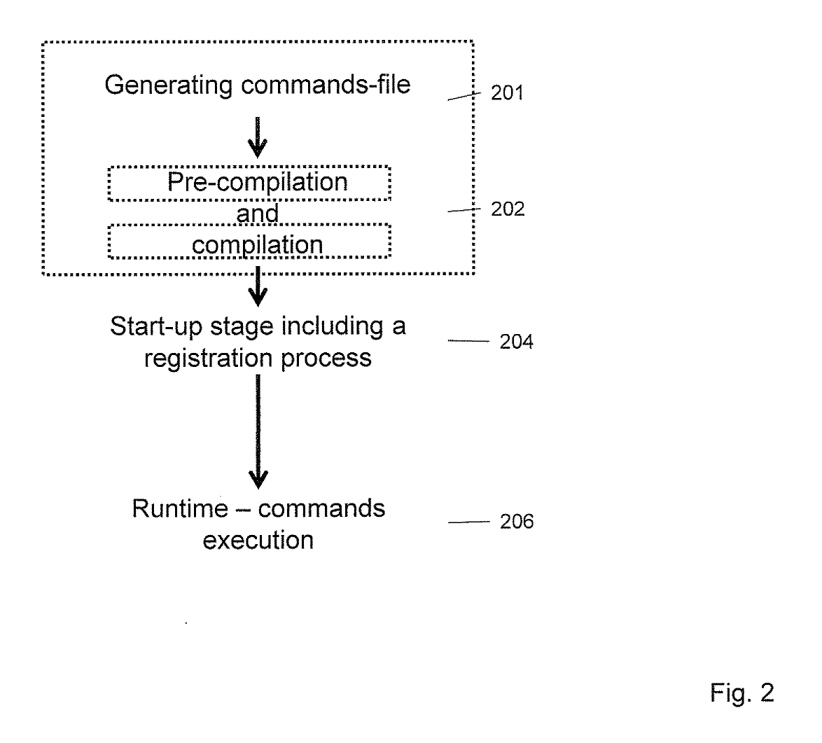

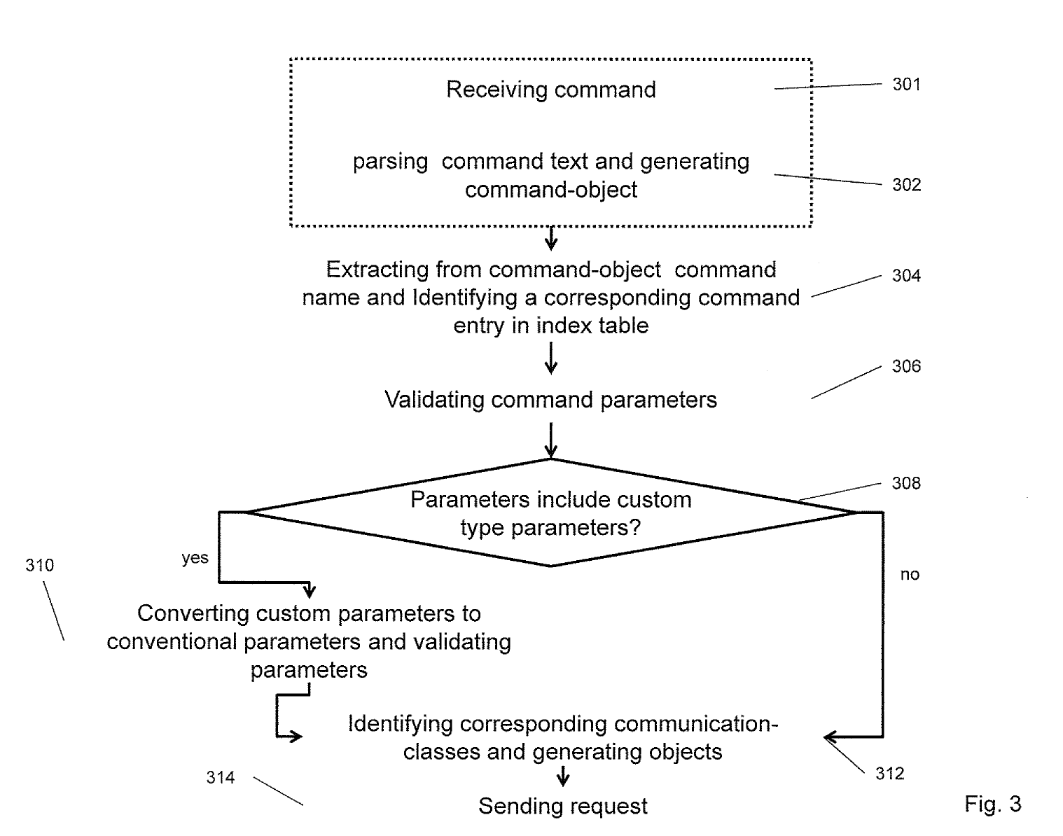

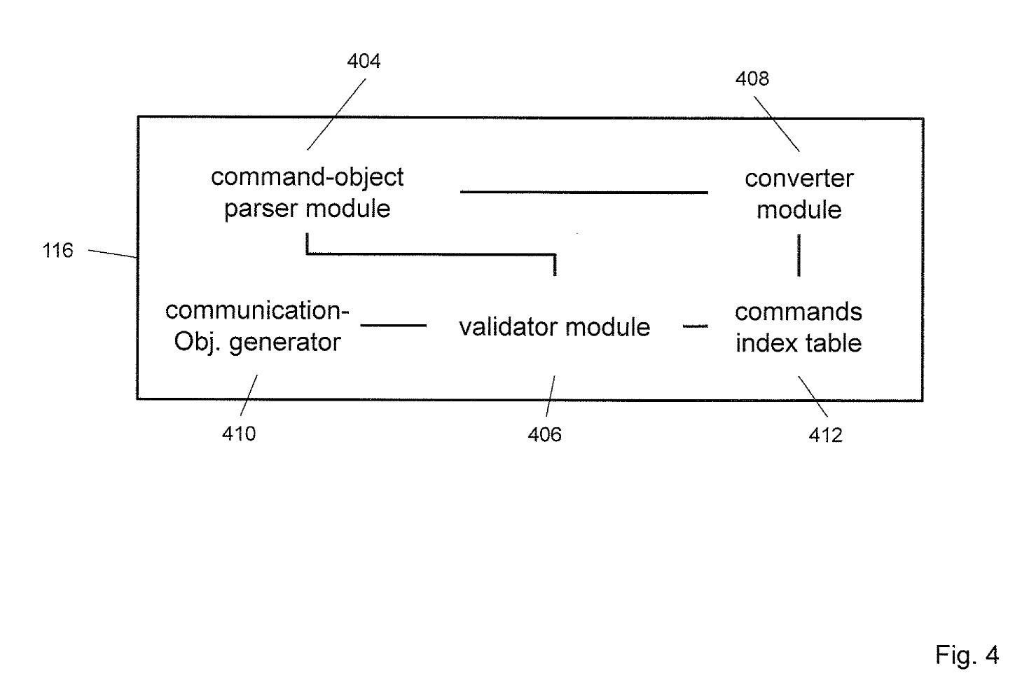

In embodiments of the presently disclosed subject matter, fewer, more and/or different stages than those shown in FIGS. 2 and 3 may be executed. In embodiments of the presently disclosed subject matter one or more stages illustrated in FIGS. 2 and 3 may be executed in a different order and/or one or more groups of stages may be executed simultaneously. FIGS. 1 and 4 illustrate a general schematic of the system architecture in accordance with an embodiment of the presently disclosed subject matter. Each module in FIGS. 1 and 4 can be made up of any combination of software, hardware and/or firmware that performs the functions as defined and explained herein. The modules in FIGS. 1 and 4 may be centralized in one location or dispersed over more than one location. In other embodiments of the presently disclosed subject matter, the system may comprise fewer, more, and/or different modules than those shown in FIGS. 1 and 4.

Turning now to a detailed description of certain embodiments of the presently disclosed subject matter, as mentioned above, in computer systems utilizing distributed computer architecture a serving processing unit is configured in order to execute tasks requested by a requesting processing unit.

A common approach for communicating information between processing units is by sending objects from one processing unit to another. In order to complete a specific task (i.e. execute a command) specific types of objects (referred herein in general as “communication-objects” or “wire-objects”) are used by the requesting and serving processing units. The requesting processing unit is configured, in response to a command, to generate a corresponding object (referred herein as a “request-object”), which specifies a requested task and send this object to the serving processing unit. The requesting processing unit can also be configured to generate an object (referred herein as a “read-response-object”) directed for enabling to read an incoming object (referred herein as a “response-object”) which is sent from the serving processing unit in response to a request-object.

On the other side, the serving processing unit is configured to receive request-objects from a requesting processing unit. The serving processing unit is further configured to process the incoming request-object and perform the task. As mentioned above the serving processing unit can also be configured to generate another type of objects (i.e. response-objects) which are sent back to the requesting processing unit in response to an incoming request-object. Communication-objects are generated from corresponding communication-classes which are available to the requesting processing unit and serving processing unit.

One example of a common mechanism used for communicating with a processing unit and initiating a command (or request) is a command-line interface (CLI). A CLI is a process implemented as a textual interface which enables a user to interact with a computer by typing commands, each command requesting the computer to perform a specific task. A CLI may be utilized for example, for interacting with a computer's own operating system or software, or for interacting between different computers. A CLI is often used for interacting with a processing unit and issuing a command to send a request to another processing unit, which can be located on the same computer or on a different computer.

This scenario can be found in some storage systems where a management process and a core process run in parallel and requests, issued for example by an administrator, are sent from the management process to the core process. The core process handles all IO activity and hence the user data. The management process handles issues that relate to the management of the storage system and that precedes or allows IO activity as desired. Such requests include for example, volume creation and deletion, snapshot creation, definition of access permissions, querying data from the core process, establishing a remote mirror for a local volume, etc.

A textual command (e.g. CLI-command issued by an administrator) is transferred to a parser module, running on the requesting processing unit, which is operable to extract the specific command and parameters from the text, identify the corresponding classes of the specified command, validate that the command format and parameters are in accord with the requirements of the command, and if so, generate the corresponding request-object and possibly also corresponding read-response-object. The request-object is then sent to a serving processing unit. Thus, the parser module is specifically configured to process each command and generate a respective request.

However, when a serving processing unit (e.g. a core process) is provided with a new capability to perform a new task (or the same task in a different way), often other processing units (e.g. on other computers in the network) are required to be equipped with corresponding capabilities for handling a command to execute the new task. More specifically, it is likely that when the ability to perform a new task is provided to one processing unit, the code on other interacting processing units (e.g. in the parser module) must undergo reprogramming in order to be adapted to the new ability and be made capable to identify and process a corresponding command. This reprogramming process is many times cumbersome and complicated, and may also give rise to errors and programming bugs which would impair the work of the reprogrammed processing unit.

Accordingly, the presently disclosed subject matter includes a system and method which enables to reduce or completely eliminate the reprogramming of a parser module in one or more processing units as a result of the reprogramming of another processing unit connected in a distributed computer-architecture.

Turning now to FIG. 1 showing a block diagram schematically illustrating a first processing unit connected to a second processing unit, in accordance with the presently disclosed subject matter. FIG. 1 depicts two processing units, 110 and 120 which are connected via some type of communication facility or network (e.g. wired or wireless network implemented by any known technology). Processing units 110 and 120 can be located on the same machine or computer or on different machines of computers. It should be noted that although FIG. 1 depicts one processing unit connected to a second processing unit, this is done for the sake of simplicity only and should not be construed as limiting and the presently disclosed subject matter includes any architecture of a single or plurality of processing units which are operable to connect and communicate with a single or plurality of other processing units. The term processing unit as used herein can refer to a processer associated with the logic of a process. Alternatively or additionally the processing unit can refer to a software implementation of the logic of a process (e.g. management process and/or core process) being embedded within an appropriate hardware which includes at least one processor and memory. Processing units can therefore include, but are not limited to, devices such as, personal or portable computers, PDAs, cellular phones or any other apparatus specifically configured for that purpose.

In the following description and for the sake of example only, processing unit 110 is a requesting processing unit operable to run a management process and processing unit 120 is a serving processing unit operable to run a core process in the context of a storage system. However, this is done only in order to more clearly convey the disclosed subject matter and it should be clear that other types of processes can be run in addition or instead of a management process and a core process. For example, in other examples processing unit 110 can be operable to run client process of some type and process 120 can be operable to run a corresponding server process of some type. It should be noted that in some cases a single processing unit can be made operable to operate as both a requesting and a serving processing unit (e.g. in a peer-to-peer network). In such cases a single processing unit can be configured with the abilities described in respect of both processing unit 110 and processing 120.

Processing unit 110 comprises or is otherwise associated with data repository 140. Data repository 140 is operable for storing, inter alia, the relevant communication-classes for generating the communication-objects. As mentioned above each command is associated with one or more corresponding communication-classes which are used handling incoming commands and responses to commands. The command classes are used in run-time for generating corresponding communication-objects and thereby enable the execution of the different commands. According to the presently disclosed subject, matter data repository 140 can also be used for storing specifically configured command-files which are required for the generic operation of the parser module as explained in more detail below.

Processing unit 110 also comprises a main process 111, which according to the current, non-limiting example is a management process in the context of a data storage system. Process 111 further comprises manager module 115, command line (CLI) interface 114, generic parser 116 and communication module 118. Process 111 is associated with at least one processor 112. Processor 112 is configured, inter alia, to manage and control relevant components and operations, and to perform tasks in response to instructions generated by process 111.

Manager 115 is configured in general for enabling to issue commands, generate request-objects and send these objects to a serving processing unit for the purpose of executing a task. More specifically manager 115 can be operable to supervise the entire process, run error checks, and determine prioritization of different request and tasks (depending for example on the requesting entity or type of the requested task) and so forth.

Processing unit 110 can be further associated with a user interface 128 (e.g. a mouse and a key pad) and a display 130 (e.g. LCD screen). User interface 128 and display 130 can be utilized by a user of processing unit 110 for issuing commands and viewing textual information in respect of outgoing commands and returning responses. Interface 128 and display 130 can be directly connected to processing unit 110 or in other scenarios processing unit 110 can be operable to communicate with another computer (e.g. server computer) running an administrator module (for example as a web application) which enables a user to indirectly interact with processing unit 110.

CLI interface 114 can run, for example, some type of user interface which is displayed on display 130 and enables a user (e.g. an administrator) to type commands in textual format, or, by means of a graphic user interface (GUI). These commands are then transferred to generic parser 116 which is operable, inter alia, to identify the relevant communication-classes which should be used in order to invoke the command and once identified to use these classes for generating corresponding communication-objects. Using 5 communication module 118, the command objects can then be serialized and sent as a byte array to processing unit 120.

According to the presently disclosed subject matter generic-parser 116 is adapted to operate together with a specifically configured one or more command-files. A command-file includes one or more structured data elements descriptive of a command which is available for execution by processing unit 110. The structured data elements are constructs packaging together data in respect of each command including the information which is required for generating a request to execute a command (i.e. descriptive). This information can include for example data in respect of a command name, command parameters and communication-classes of a respective command. In some cases a single command-file can be used to comprise data elements of all commands while in other cases a plurality of command-files can be used each comprising data elements corresponding to one or more commands. The data comprised in the command-file is registered in the computer memory associated with processing unit 110.

Generic-parser 116 is configured, in response to an issued command to search, in the computer memory, (e.g. based on the command name), for data comprised in the data-elements, which is now registered in the computer memory, including information corresponding to the command. The information stored in the computer memory is used to validate the command and command parameters. In case no error is found in the command (i.e. command is verified) generic parser 116 can identify corresponding communication-classes. These classes can then be used (e.g. by generic parser 116) to generate the corresponding communication-objects (e.g. request-object and read-response-object) and invoke a request to serving processing unit 120, to perform a corresponding task.

The specific configuration of generic parser 116 and the use of a specifically configured command-file enable to use the same parser for processing and invoking any command which is appropriately represented within a command-file. As the information required for executing a request to execute a command (i.e. descriptive of a command) is available from the command-file, and this information is available to generic parser 116 in run-time, generic parser 116 does not have to be specially configured to process each specific command. Accordingly, when a new or modified command is introduced to the serving processing unit 120, a command-file can be updated with new data corresponding to the new (or modified command) while the rest of process 111 (including generic parser 116) can be used without any reprogramming, thereby substantially reducing the requested reprogramming. A more detailed description of the operation of processing unit 110 and generic parser 116 is provided below.

Turning now to processing unit 120, it comprises or is otherwise associated with data repository 145. Data repository 145 is operable for storing, inter alia, the relevant communication-classes for generating the communication-objects. As mentioned above in response to a request-object, serving processing unit 120 can be configured to generate a response-object. Thus, a command can be associated with a corresponding class (referred herein as “response-class”) which is used by serving processing unit 120, for generating a response-object. Data repository 145 can be operable for storing classes for generating corresponding object directed for processing incoming request-objects, send by processing unit 110.

Processing unit 120 further comprises a main process 121, which according to the current, non-limiting, example is a core process in the context of a data storage system. The core process includes a communication module 124 which is operable, in general, to communicate with other processing units and specifically with processing unit 110. A byte array of a request-object which is sent from processing unit 110 is received by communication module 124 which can be operable to reconstruct the request-object from the incoming byte array. The reconstructed objects are then transmitted to request manager 126.

Request manager 126 is operable to process the incoming request-object (e.g. by the use of appropriated objects) and send the request-object itself to an appropriate command executor module 128 operable to execute the relevant task. Main process 121 can be associated with one or more command executors 128, each operable to complete one or more tasks. Request manager 126 can be further operable to identify the corresponding response-class and use it to generate a response-object and send the response-object, as a reply to requesting processing unit 110. The response-object can be serialized by communication module 124 and sent to processing unit 110 as a byte array. The response-object can be generated and sent immediately once the request is received by the server or following the execution of the requested task. Processing unit 120 also comprises at least one processer 122 which is configured, inter alia, to manage and control relevant components and operations, and to perform tasks in response to instructions generated by process 121.

Turning back to processing unit 110, the response-object is received by communication module 118 which can be made operable to reconstruct the response-object from the incoming byte array. The reconstructed object is then processed by process 111 which can for example, display incoming messages on display 130 possibly with the help of a GUI.

Data-repositories 140 and 145 can be directly associated with processing unit 110 and processing unit 120 respectively, for example they may be located on the same device as the corresponding processing unit, or directly connected to the device of the corresponding processing unit. Alternatively or additionally, data-repositories 140 and 145 can be located on a remote device which is accessible to processing units 110 and 120 respectively, via any type of communication facility or network (e.g. wired or wireless network). Data-repositories 140 and 145 can be configured as a number of distributed data-repository units or as a single data-repository unit.

In general requesting and serving processing units can communicate with each other using some type of communication (data serialization) protocol. For example data serialization formats include: JSON, XML, YAML, and ASN.1 and others. An extensive list of such protocols can be found in: http://en.wikipedia.org/wiki/Comparison_of_data_serialization_formats.

One example of a data serialization protocol is Google's Protocol Buffers utility (abbreviated Protobuff). Protobuff is an automated mechanism for serializing structured data. Protobuff enables to create relatively simple structures representing the desired classes of the communicating processing units and then by using specifically generated source code, to easily write and read the structured data to and from a variety of data streams by using a variety of languages (For more information with regard to Protobuff see http://code.google.com/p/protobuf/). As explained below, in accordance with the presently disclosed subject matter, Protobuff runs as part of the pre-compiling process of processing units 110.

The process running on requesting processing unit 110 (e.g. management process) and the process running on serving processing unit 120 (e.g. core processing unit) can be written in different languages. For example in some cases the first process is written in Java and the latter is written in C++. Thus the objects which are sent back and forth between the communicating processing units should be adapted to the language used by the corresponding processing unit.

FIG. 2 is a flowchart showing the principle operations carried out by requesting processing unit 110, in accordance with the presently disclosed subject matter. FIG. 2 shows three main stages including: a pre-recompiling and compilation stage (block 202), a start-up stage (block 204) and a run-time stage (block 206).

As mentioned above, in accordance with the presently disclosed subject matter, a specifically configured command-file is used by processing unit 110. The command-file can be generated before the pre-compilation and compilation stage (202) or in some cases it can be generated as part of the pre-compilation and compilation 202. The data elements in the command-file are written according to a predefined format which is familiar to the process running on processing unit 110 and more specifically to generic parser 116. The command-file is not limited to a certain computer language or format and can be written in different languages or formats or even as a text document.

A command-file can be written for example as an Extensible Markup Language (XML) document (i.e. an xml command-file). Data elements in an xml command-file are represented as xml data elements. In the context of the current non-limiting example, directed to a management and a core processes in a storage system, the xml command-file is referred herein as a core.xml. Each command is represented in the xml file by one or more xml data elements. These xml data elements can include for example a <MESSAGE> element a <COMMAND> element and a <WIRE_OBJECT> element.

The <MESSAGE> is a data structure including different attributes defining an entity which is the subject of a command. For example, in the context of a storage system one type of a <MESSAGE> element is “volume” which represents a volume in a storage system. In general the term “volume” (or logical volume) in the context of a storage system includes a virtual entity logically presented to a client as a single virtual storage device, usually encompassing a defined storage space. Volumes can be created or deleted within a storage system and can have different sizes. One possible command in respect of a volume is “create.volume” which is a command requesting from the core process to create a volume in a storage system. Another example is “delete.volume” which is a command requesting from a core process to delete a specific volume. Note that both commands refer to the same type of <MESSAGE> data element i.e. “volume”.

For example, a “volume” type <MESSAGE> xml data element in a core.xml file, in accordance with the presently disclosed subject matter, can look as follows:

```
<MESSAGE name=“Volume”>
  <FIELD name=“name” type=“string” rule=“required” nickname=“name”/>
  <FIELD name=“user_size” type=“VSIZE” rule=“required” nickname=“size”/>
  <FIELD name=“guaranteed_size” type=“VSIZE” rule=“optional” nickname=“gsize”/>
  <FIELD name=“disk_usage” type=“VSIZE” rule=“optional” nickname=“du”/>
  <FIELD name=“volume_id” type=“int64” rule=“optional” nickname=“id”/>
  <FIELD name=“snap_id” type=“int32” rule=“optional” nickname=“snap”/>
  <FIELD name=“type” type=“VolumeType” rule=“optional”/>
  <FIELD name=“num_snaps” type=“int64” rule=“optional” nickname=“#snaps”/>
  <FIELD name=“num_luns” type=“int64” rule=“optional” nickname=“#luns”/>
  <FIELD name=“read_only” type=“bool” rule=“optional” nickname=“ro”/>
  <FIELD name=“creation_time” type=“DATE” rule=“optional” nickname=“created”/>
  <FIELD name=“last_access_rdtime” type=“DATE” rule=“optional” nickname=“last_read”/>
  <FIELD name=“last_access_wrtime” type=“DATE” rule=“optional” nickname=“last_write”/>
  <FIELD name=“stats” type=“VolumeStats” rule=“optional”/>
  <FIELD name=“trie_state” type=“TrieState” rule=“repeated”/>
  <FIELD name=“description” type=“string” rule=“optional”/>
</MESSAGE>
```

Each line in the <MESSAGE> defines a property which characterizes a corresponding volume. For example, the first line specifies the type of the <MESSAGE>, the second line specifies the name of a specific “volume” type <MESSAGE> element (e.g. “volume100”). The third line specifies the requested volume size. Note that in the <MESSAGE> data element indicates in respect of each parameter whether it is a required variable or an optional variable.

A second xml data elements is <WIRE_OBJECT> which is a structure representing the communication-classes of processing unit 110, including at least a class for generating the request-object and the class for generating a corresponding read-response-object. The <WIRE_OBJECT> xml data element includes different fields, including the name of the corresponding command and the name of the corresponding <MESSAGE> element, being the subject of the respective command.

For example, a <WIRE_OBJECT> data element in a core.xml file, in accordance with the presently disclosed subject matter, can look as follows:

```
<WIRE_OBJECT name=“VolumeCreate”>
  <REQUEST>
    <FIELD name=“name” type=“NAME” rule=“required” nickname=
    “name”/>
    <FIELD name=“description” type=“STRING” rule=“optional”
    nickname=“descr”/>
    <FIELD name=“user_size” type=“VSIZE” rule=“required”
    nickname=“size”/>
    <FIELD name=“guaranteed_size” type=“VSIZE” rule=“optional”
    nickname=“gsize”/>
  </REQUEST>
  <RESPONSE>
    <FIELD name=“status” type=“Status” rule=“required”/>
  </RESPONSE>
</WIRE_OBJECT>
```

Note that in the current example <WIRE_OBJECT> name is “volume. create”.

A third xml data element is a <COMMAND> element. The <COMMAND> element is a structure which is configured for linking between an issued command and its corresponding data elements in the 5 command-file and the corresponding communication-classes.

For example, a core.xml <COMMAND> xml data element, in accordance with the presently disclosed subject matter, can look as follows:

```
<COMMAND name=“volume.create” wire_object=“VolumeCreate”>
  <MANDATORY_FIELD name=“name”/>
  <MANDATORY_FIELD name=“user_size”/>
</COMMAND>
```

Note that in the <COMMAND> xml data element includes the name of the corresponding <WIRE_OBJECT> element, which in the current example is “VolumeCreate”. Xml elements of different types having the same name can be associated with each other based on the name.

It should be noted that as mentioned above, xml data elements are only one non-limiting example of a type of data elements that can be used in a command-file, in accordance with the presently disclosed subject matter. While xml data elements are described herein as an example, in order to more clearly convey the disclosed subject matter, other types of data elements can be used instead or in additional to xml data elements.

In general during the pre-compilation and compilation stage (Block 202) the code required in run-time for executing commands is generated. According to some examples the operations which are performed during per-compilation and compilation stage (202) can be performed on a different machine (e.g. computer) or by a different processing unit than processing units 110. According to other examples the processing unit 110 can be operable to execute the operation performed during stage 202. The pre-compilation and compilation processes illustrated in block 202 in FIG. 2 are denoted with a broken line to indicate that this processes can be executed as single unified stage or as two separate stages, being executed for example by a processing unit different than processing unit 110.

During this stage (as part of the pre-compilation process) a special conversion script can be run on the generated command-file, configured for converting the command-file into a communication protocol file format, in which data elements in the command-file are represented in a format which can be used as part of the communication (or serialization) protocol used for communicating between processing unit 110 and processing unit 120. To this end a code written in some type of script language (for example python) can be used.

In the current example the code can be configured for converting the xml data elements into a format compatible with some type of communication protocol. One example of such protocol is Protobuff. The conversion script can thus be configured to convert the xml data elements into corresponding data elements in Protobuff format. The processing of the xml command-file results in the generation of a communication protocol file (comm-protocol file). In the example of Protobuff the name of the file can be called core.proto. This file contains part of the information defined in xml, which includes the information which is required for creating the communication-classes. <MESSAGE> and <WIRE_OBJECT> xml elements, are shown below in their converted format (after being converted into Protobuff format) as they appear in a core.proto file:

message Volume {

| | | | |
|---|---|---|---|
| required | string | name | = 1; |
| required | int64 | user_size | = 2; |

| | | | |
|---|---|---|---|
| optional | int64 | guaranteed_size | = 3; |

| | | | |
|---|---|---|---|
| optional | int64 | disk_usage | = 4; |
| optional | int64 | volume_id | = 5; |
| optional | int32 | snap_id | = 6; |
| optional | VolumeType | type | = 7; |
| optional | int64 | num_snaps | = 8; |
| optional | int64 | num_luns | = 9; |
| optional | bool | read_only | = 10; |
| optional | int64 | creation_time | = 11; |

| | | | |
|---|---|---|---|
| optional | int64 | last_access_rdtime | = 12; |
| optional | int64 | last_access_wrtime | = 13; |

| | | | |
|---|---|---|---|
| optional | VolumeStats | stats | = 14; |
| repeated | TrieState | trie_state | = 15; |
| optional | string | description | = 16; |
| } | | | |

message VolumeCreateRequest {

| | | | |
|---|---|---|---|
| required | string | name | = 1; |

| | | | |
|---|---|---|---|
| optional | string | description | = 2; |

| | | | |
|---|---|---|---|
| required | int64 | user_size | = 3; |

| | | | |
|---|---|---|---|
| optional | int64 | guaranteed_size | = 4; |
| } | | | |

message VolumeCreateResponse {

| | | | |
|---|---|---|---|
| required | Status | status | = 1; |
| } | | | |

After the comm.-protocol file (e.g. core.proto) has been generated from the core.xml file, the converted data elements are in a format which can be used in combination with a Protobuff protocol commands to generate JAVA and CPP source code, including the communication-classes for communicating between the management and the core processors. As part of the compilation process, the data elements in the core.proto file can be used to automatically generate the communication classes of both the management process (in the current example, in Java) and of the core processes (in the current example, in C++). The management communication-classes can be stored for example in data repository 140 and the core communication-classes can be stored in data repository 145. Accordingly as apparent from the above, the command-file can be used together with Protobuff for enabling the automatic generation of the communication-classes. In other examples communication-classes can be generated in other methods, for example be written manually by a programmer. Thus, during the compilation process communication-classes can be generated for both management process and core process. The conversion script can be run, for instance, as part of the MAKE process.

The following list summarizes, at least part, of the source code which is compiled during the pre-compilation and compilation stage:

1. The code for running process 111 and the code for running process 121, both of which can be written for example by a programmer. Note that according to the present, non-limiting, example process 111 is written in Java while process 121 is written in C++.

2. The communication classes. As explained above these classes can be automatically generated from the comm-protocol file (e.g. core.proto) during the pre-compilation and compilation stage.

3. The command-file (e.g. core.xml).

4. Generic parser 116 which is a module configured to work as part of processing unit 110 (e.g. running management process) and create communcation-objects in response to respective incoming commands. As explained in more details below generic parser 116 can create the request object by using information which is available in the command-file.

After the pre-compilation and compilation processes are completed, the executable code thus produced is available and can be loaded for running the management and core processes respectively. The system is now ready to turn to startup stage 204. During the startup stage 204 generic parser 116 performs a registration process. During the registration process generic parser 116 registers (in the computer memory) the commands, which are comprised in the command-file as data elements (e.g. <COMMANDS> data elements), in order to create a data structure (e.g. a hash table) representing all available commands, where each command can be indexed and identified e.g. by its name (i.e. the command name being the key for finding a corresponding command). The data structure is referred below as “commands index table”. Each entry in the commands index table representing a command is associated with the relevant information in respect of the command, including for example, information in respect of the command parameters, (such as the type of the parameter and its corresponding validators class and/or convertor class) and corresponding communication-classes. The information which is registered in the commands index table, during the registration processes, enables generic parser 116, to validate and execute an incoming command in runtime.

To this end the command-file can include another type of data element named <COMMANDS> which lists all available <COMMAND> data elements. The information in respect of each command and its parameters can be obtained from the corresponding <COMMAND> and <WIRE_OBJECT> data elements.

The information about a command's parameters is taken from <REQUEST> data element in the <WIRE_OBJECT> data element within the xml file. For example, the definitions of parameters of a “volume.create” command can be taken from the following <WIRE_OBJECT>:

```
<<WIRE_OBJECT name=“VolumeCreate”>
  <REQUEST>
    <FIELD name=“name” type=“NAME” rule=“required” nickname=
    “name”/>
    <FIELD name=“description” type=“STRING” rule=“optional”
    nickname=“descr”/>
    <FIELD name=“user_size” type=“VSIZE” rule=“required”
    nickname=“size”/>
    <FIELD name=“guaranteed_size” type=“VSIZE” rule=“optional”
    nickname=“gsize”/>
  </RESPONSE>
...
</WIRE_OBJECT>
```

Note that the <REQUEST> data element specifies the different command's parameters and whether each parameter is required or optional.

Another advantage of using a command-file, in accordance with the presently disclosed subject matter, is that it allows defining custom parameter types for the commands (i.e., parameters other than the standard parameters types such as: string, integer, long, etc.) and automatically converting these custom type parameters into conventional parameters in runtime. Thus, for instance, in the context of a storage system, custom type VSIZE can be used to represent a parameter type that characterizes the size of a Volume. For example, the parameter's values can be written as ‘1G’, meaning a size of 1 Giga Byte.

According to the presently disclosed subject matter, each custom type parameter that is used is represented in the command-file by a corresponding data element. For example, in the example of an xml command-file an xml data element <TYPES>, which contains various <TYPE> elements, can be used. Each <TYPE> data element represents a custom type parameter. Thus, for instance for the custom type VSIZE, the following <TYPE> data element can be used:

<TYPE name =“VSIZE” convertedType=“int64”
converterClass=“com.xn.mgmt_proc.mgmt_parser.converter.
VolumeSizeParam Converter”
validatorClass=“com.xn.mgmt_proc.mgmt_parser.validator.
VolumeSizeValidator”/>

Here int64 is a variable type commonly used by protobuff, and the other two lines indicate the paths to a respective validator class (e.g. ParamValidator) and a respective converter class (e.g. ParamConverter). Wherein the validator classes is configured for generating a corresponding object for enabling the validation of an incoming custom parameter and the converter class is configured for generating a corresponding object for converting a custom type parameter into a conventional type parameter. The path to these classes can be defined in the command-file as part of the <TYPE> data element.

Notice above that the attribute “type” in each <FIELD> of a <MESSAGE> data element indicates which <TYPE> data element should be used to validate and convert the corresponding custom type parameter. For example, the type “VSIZE” is represented in command string with the name “user_size” (or “size”), indicating that a <TYPE> data element named “VSIZE” should be used to validate and convert “user_size” parameters in a “create.volume” command.

During the registration process each custom type parameter, which represented in the command-file by a <TYPE> data elements, is identified and registered in association with its corresponding converter and validator classes which are specified in the corresponding <TYPE> data element. Furthermore, during the registration process each command entry listed in the commands index table, described above, which is associated with one or more custom type parameters is identified and each custom type parameter is associated with the information (e.g. the table entry) of a corresponding <TYPE> data element.

This enables generic parser 116, to receive a command with one or more custom type parameters, and convert and validate the custom parameters in runtime. For example, when generic parser 116 receives a parameter with the name “user_size” the corresponding converter and validator classes for validating and converting the “user_size” parameter can be identified and used for converting and validating the parameter into its convectional counterpart parameter type.

After the registration of custom parameter types and commands is complete, the system is ready for work and requesting processing unit 110 can turn to processing received commands (stage 206).

Turning now to FIG. 3 which is flowchart showing the operations carried out by requesting processing unit 110 during runtime, in accordance with the disclosed subject matter. FIG. 4 is a block diagram schematically illustrating functional components of generic parser 116, in accordance with the presently disclosed subject matter. In the following description of the operation illustrated with reference to FIG. 3, where appropriate, reference is made to corresponding functional component in FIG. 4. FIG. 4 illustrates a non-limiting example and should not be construed as limiting.

In the first stage processing unit 110 receives a command directed to processing unit 120 and instructing it to perform a task (Block 301). The command can be initiated by a user of processing unit 110, who can be for example an administrator (e.g. an administrator of a management process). In other cases the command can be initiated automatically, for example by another processing unit. The command can be transmitted to generic parser 116 from CMD interface 114.

A command can be initiated as a textual command (e.g. CLI command) via a CLI user interface. The textual command is parsed and the name of the command and its parameters are extracted from the text. In accordance with the presently disclosed subject matter this information can then used in order to generate a special type of object (referred herein as a “command-object”, named for example, CliCommand object) which is used to package the command's name and parameters. In addition or instead to a CLI user interface a command can be issued via a graphical user interface (GUI). For example, a windows type GUI where a command is invoked by clicking on an appropriate icon. Depending on the specific configuration, this may result in the generation of either a corresponding (CLI) textual command or it can result in the generation of an appropriate command-object.

The parsing of the textual command and generation of the command-object (e.g. CliCommand) can be performed for example by command (CMD) interface 114, once the command is received (Block 302). In some cases and some system configurations these operation can be performed by a process running on a computer external to processing unit 110. In such cases the command is received in processing unit 110 in the form of a command-object.

A command-object, in accordance with the presently disclosed subject matter, can look for example, as follows:

```
public class CliCommand{
    private String cmdName;
    private HashMap<String,CliCmdParameter> parameters;
    private String mandatoryParamsStr;
    private String helpMessageName;
    private String requestClassName;
    private ApiObjectType requestType;
    private CmdDestination destination;
    private String filterName;
}
```

Each CliCommand contains a map of its accompanied parameters, which are represented by another nested parameters-object (named for example “CliCmdParameter object”).

A parameters-object, in accordance with the presently disclosed subject matter, can look for example, as follows:

```
public class CliCmdParameter {
    //name or nickname if present in <FIELD> of core.xml
    private String name;
    private String type;
    //name in <FIELD> of core.xml
    private String realName;
}
```

Once a command-object (e.g. CliCommand) is received by generic parser 116, generic parser 116 (e.g. by a command-object parser module 404) is operable to extract from the command-object the command name and use the command name to identify a corresponding command-entry in the commands index table (block 304). This stage represents the first validation stage, as in case the command name is not found in the command index table an error message can be returned indicating that a wrong command name is used.

In case the command name is found in the commands index table the parameters in the command-object are validated using the information specified in the commands index table (Block 306). Generic parser 116 (e.g. by validator module 406) is operable to obtain information about each parameter from the commands index table and compare this information with the parameters which are received together with the command in the command-object. For example, validation can include (but is not limited to), the following operations:
Checking whether all mandatory variables were received with the command-object. To this end generic parser 116 can check whether all parameters which are indicated in the commands index table as required were received with an incoming CliCommand object.
Checking whether each parameter is appended with a value of the correct type. This can be accomplished for example by checking the parameter type which is indicated in the commands index table and comparing to the value type of a value appended to a corresponding parameter extracted from the command-object.

Operations related to validation can be accomplished by utilizing appropriate one or more validator-objects, which can be generated by generic parser 116 from corresponding validator-classes. Relevant validator-classes are associated with the command in the commands index table and can be thus identified by generic parser 116.

During runtime in case a command-object includes a custom type parameter these parameters undergo a special validation and conversion process. During this process the parameter is automatically converted by generic parser 116 to its corresponding conventional type and then validated.

To that end generic parser 116 is operable (e.g. by converter module 408) to identify whether a custom type parameter was received with the command-object (Block 308). This can be done, for example, by identifying a parameter name (e.g. “user_size”) and checking whether it is identified in the commands index table as a custom type (being associated in the command-file with a special <TYPE> data element). In case a custom type parameter identified generic parser 116 (e.g. by converter module 408) is further configured to utilize corresponding converter classes to generate corresponding converter objects and convert the values of the custom type into values of a conventional type parameter. Once converted the converted parameters can also be validated using appropriated validator classes in accordance to the specification in the commands index table (Block 310). The commands index table indicates the path to corresponding converter and validator classes which enables to convert and validate the parameter. In this way all parameters can be automatically validated in run-time, regardless of their type.

As part of the conversion process from the command-file to the communication protocol file, which as described above takes place during the pre-compilation stage 202, custom types in the command-file (e.g. core.xml) can be converted into respective conventional variable types in the communication protocol file (e.g. core.proto). For example, a VSIZE will be converted into a Long variable type, which stores values up to 2̂30 bytes. Thus, a custom variable type can be defined in a data element in the command-file (e.g. xml.core) and then be automatically converted to corresponding conventional variable types, to be used in the communication classes. During run-time a custom type command parameter is automatically converted to a conventional type while the communication class is preconfigured to use the right type of parameter.

Once the received parameters are validated (and converted, if needed), generic parser 116 (e.g. by communication-Obj. generator 410) is operable to identify, with the help of the commands index table, corresponding communication-classes which were generated during stage 202 and generate corresponding communication (wire) objects with the received parameters (e.g. a request-object and a read-response-object) (Block 312). The generation of the objects can be completed for example by communication-object generator 410. The request-object can then be sent to the serving processing unit 120 (Block 314) using e.g. comm. module 118.

Serving processing unit 120 receives and processes the incoming request-object and attempts to execute the requested task. As explained above, in response to the received request-object, processing unit 120 generates a response-object and sends the response object back to requesting processing unit 110.

Requesting processing unit 110 receives the response object and can utilize the read-response-object in order to process the incoming response object, read its content and display the content on display 130.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

1. A method of operating a processing unit, the method comprising, in run-time:
a. obtaining by said processing unit a command-object corresponding to a command, said command being designated to said processing unit and being related to a task to be performed by a second processing unit;
b. searching, in a data structure comprised in a memory associated with said processing unit, for information in respect of said command, wherein said data structure corresponds to a command-file, said command-file is descriptive of said command, and is generated before run-time in correspondence with said command and comprises one or more structured data elements;
c. generating by said processing unit one or more communication-objects corresponding to said information in respect of said command; and
d. sending at least one of said generated communication-objects to said second processing unit thereby requesting said second processing unit to perform said task.

2. The method according to claim 1 further comprising: before said obtaining of said command-object, obtaining information in respect of one or more commands from said command-file and registering said information on said memory, thereby generating said data structure.

3. The method according to claim 1 wherein said method further comprises extracting from said command-object at least a command name; and wherein said searching of said information is made based on said command name.

4. The method according to claim 1 further comprising: identifying one or more communication-classes corresponding to said command, based on said information in respect of said command in said data structure, and generating said communication-objects from said communication-classes.

5. The method according to claim 3, wherein said command-objects comprises one or more parameters and the method further comprises, validating the command name and command parameters of said command based on said information.

6. The method according to claim 5 wherein said information includes at least one or more of the following:
a. data indicating whether the command is registered;
b. data indicating a name and a corresponding type of each parameter of a respective command; and
c. data indicating whether each parameter of a respective command is required or optional.

7. The method according to claim 1 wherein said information further includes data for enabling converting custom type parameters to conventional type parameters, the method further comprising:
a. extracting from said command-object one or more parameters of a respective command;
b. identifying at least one custom type parameter;
c. converting said custom type parameter to a conventional type parameter with the help of a corresponding converter-object; said converter-object configured for converting a value of said custom type parameter to a value of conventional type.

8. The method according to claim 7 further comprising: before said converting, identifying based on said information in said data structure a respective converter-class and generating from said converter class said corresponding converter-object.

9. The method according to claim 1, wherein said data elements in said command-file include at least a message data element, a command data element and wire object data element.

10. The method according to claim 1, wherein said command-file is an xml file and said data elements are xml data elements.

11. The method according to claim 1 wherein said command-object is generated by the processing unit.

12. The method according to claim 1 wherein said command-object is generated in response to a CLI command, issued to said processing unit by a user.

13. A method of enabling a first processing unit, in response to a command designated to said first processing unit and being related to a task to be performed by a second processing, to request from said second processing unit to perform said task, the method comprising:
a. generating a command-file, said command-file descriptive of at least said command and comprising one or more structured data-elements;
b. registering data comprised in the data-elements in a data structure stored in a memory associated with said first processing unit and available to said first processing unit in run-time, thereby enabling said first processing unit to generate in run-time, with the help of said information, one or more communication objects corresponding to said command; said communication object includes at least a request-object, said request-object being configured to be sent to said second processing unit and request said second processing unit to perform a respective task.

14. The method according to claim 13, wherein said command-file includes all the information sufficient for executing a request to execute a command.

15. The method according to claim 13, wherein said information enables to identify one or more communication classes corresponding to said one or more communication object, respectively, the method further comprising: generating a corresponding communication protocol file from said information in said command-file, and with the help of said communication protocol file automatically generating said one or more communication classes, before run-time, thereby enabling to generate said communication objects in run-time.

16. The method according to claim 15 wherein said communication classes include communication class corresponding to both said first processing unit and said second processing unit.

17. The method according to claim 13 further comprising:
c. obtaining a command-object corresponding to said command;
d. searching, in said data structure, for information in respect of said command;
e. generating, with the help of said information, one or more communication objects including at least said request-object; and
f. sending at least one of said generated communication objects to a second processing unit thereby requesting said second processing unit to perform said task.

18. The method according to claim 13 wherein said data structure is a hash table stored on said memory.

19. The method according to claim 13 wherein said command-object comprises one or more parameters of said command.

20. The method according to claim 13 wherein said information includes data for enabling validating said command.

21. The method according to claim 20 wherein said information includes at least one or more of the following: data indicating whether the command is registered in said data structure; data indicating a name and a corresponding type of each parameter of a corresponding command; and data indicating whether each parameter of a corresponding command is required or optional.

22. The method according to claim 21 further comprising: validating the command name and command parameters with the help of said information.

23. The method according to claim 17 wherein said information further includes data for enabling converting custom type parameters to conventional type parameters, the method further comprising:
a. extracting from said command-object one or more parameters of a respective command;
b. identifying at least one custom type parameter;
c. converting said custom type parameter to a conventional type parameter with the help of a corresponding converter-object; said converter-object configured for converting a value of said custom type parameter to a value of conventional type.

24. The method according to claim 13, wherein said one or more structured data elements in said command-file include at least, a message data element, a command data element and wire object data element.

25. The method according to claim 13, wherein said command-file is an xml file and said data elements are xml data elements.

26. The method according to claim 13 wherein said data structure is a hash table stored on said memory.

27. A first processing unit operable, in response to a command, to request from a second processing unit to perform a respective task, wherein the first processing unit is operable to obtain a command-object corresponding to said command and comprises:
a generic parser and a communication module,
wherein the generic parser is operable to search, in a data structure, comprised in a memory associated with said first processing unit, for information in respect of said command; wherein said data structure corresponds to a command-file, said command-file is generated before run-time in correspondence with said command and comprises one or more structured data elements descriptive of said command;
said generic parser is further operable to generate one or more communication-objects corresponding to said information in respect of said command; and
said communication module is operable to send at least one of said generated communication-objects to said second processing unit thereby requesting said second processing unit to perform said task.

28. The first processing unit according to claim 27 wherein said generic parser is further operable to identify one or more communication-classes corresponding to said command, based on said information in said data structure in respect of said command, and to generate said communication-objects from said one or more communication-classes.

29. The first processing unit according to claim 28 wherein said one or more communication-classes are automatically generated, before run-time with the help of a communication protocol file; said communication protocol file is generated from said information in said command-file, thereby enabling to generate said communication objects in run-time.

30. The first processing unit of claim 29 is further operable to generated said communication protocol file.

31. The first processing unit according to claim 27, wherein said command-file includes all the information sufficient for executing a command.

32. The first processing unit according to claim 27, wherein said command-object comprises a command name and one or more parameters and said generic parser is further configured to validate the command name and command parameters of said command based on said information.

33. The first processing unit according to claim 33 wherein said information includes at least one or more of the following:
a. data indicating whether the command is registered;
b. data indicating a name and a corresponding type of each parameter of a respective command; and
c. data indicating whether each parameter of a respective command is required or optional.

34. The first processing unit according to claim 27 wherein said information further includes data for enabling converting custom type parameters to conventional type parameters, the generic parser is further operable to extract from said command-object one or more parameters of a respective command; identify at least one custom type parameter; convert said custom type parameter to a conventional type parameter with the help of a corresponding converter-object; said converter-object is configured for converting a value of said custom type parameter to a value of conventional type.

35. The first processing unit according to claim 35 wherein said generic parser is further configured to identify based on said information in said data structure a respective converter-class and generate from said converter class said corresponding converter-object.

36. The first processing unit according to claim 27, wherein said data elements in said command-file include at least a message data element, a command data element and wire-object data element.

37. The first processing unit according to claim 27, wherein said command-file is an xml file and said data elements are xml data elements.

38. The first processing unit according to claim 27 wherein said command-object is generated by the first processing unit.

39. The first processing unit according to claim 27 being a management processing unit and said second processing unit is a core processing unit in a data storage system.

40. A generic parser operatively connectable to a first processing unit, operable, in response to a command, to request from a second processing unit to perform a respective task, wherein the first processing unit is operable to obtain a command-object corresponding to said command,
said generic parser is operable responsive to receiving said command-object to search, in a data structure, comprised in a memory associated with said first processing unit, for information in respect of said command; wherein said data structure corresponds to a command-file, said command-file is generated in advance in correspondence with said command and comprises one or more structured data elements descriptive of said command; and
generate at least one or more communication-objects corresponding to said information in respect of said command; thereby enabling said first processing unit to send at least one of said generated communication-objects to said second processing unit and request said second processing unit to perform said task.

41. A program storage device readable by machine, tangibly embodying a program of instructions executable by the machine to perform method steps of operating a processing unit, the method comprising:
a. obtaining by a first processing unit a command-object corresponding to a command, said command being designated to said first processing unit and being related to a task to be performed by a second processing unit;
b. searching, in a data structure comprised in a memory associated with said first processing unit, for information in respect of said command, wherein said data structure corresponds to a command-file, said command-file is descriptive of said command, and is generated in advance in correspondence with said command and comprises one or more structured data elements;
c. generating by said first processing unit one or more communication-objects corresponding to said information in respect of said command; and
d. sending at least one of said generated communication-objects to said second processing unit thereby requesting said second processing unit to perform said task.
